(19) United States
(12) Patent Application Publication
(10) Pub. No.: US 2019/0193098 A1
(43) Pub. Date: Jun. 27, 2019

(54) PRESSURIZABLE BEVERAGE BOTTLE

(71) Applicants: KENNETH A. HARBAUGH, VILLA RICA, GA (US); LIN ZHAO, GUANGDONG (CH)

(72) Inventors: KENNETH A. HARBAUGH, VILLA RICA, GA (US); LIN ZHAO, GUANGDONG (CH)

(21) Appl. No.: 16/206,451

(22) Filed: Nov. 30, 2018

Related U.S. Application Data
(60) Provisional application No. 62/593,262, filed on Dec. 1, 2017.

(51) Int. Cl. B05B 9/043; B05B 7/24

(52) U.S. Cl. CPC B05B 9/043; B05B 7/2491

(57) ABSTRACT

A beverage bottle is pressurizable to permit a liquid in the bottle to be dispensed without the user having to lift or tilt the bottle. A reciprocating piston is mounted within the lid. The user exerts a downward force on the piston to force air into the bottle, pressurizing the contents. A spring returns the piston to its uppermost position. An outlet port connects to a flexible hose with a stopcock at its free end. The beverage in the bottle can be dispensed by opening the stopcock.

### CROSS-REFERENCE TO RELATED APPLICATIONS

The present application claims priority of U.S. Provisional Application No. 62/593,262, filed Dec. 1, 2017.

### BACKGROUND OF THE INVENTION

### Technical Field

The present invention relates generally to beverage containers and more specifically to a pressurizable beverage bottle having a beverage dispensing system.

### Background Art

Water bottles are known in which the bottle has spaced apart double walls with a vacuum in the space between the walls to provide enhanced thermal insulation qualities. To transfer some or all of the contents of the water bottle to a separate drinking cup, the top of the bottle typically must be removed and the bottle tipped to pour fluid from the bottle into the cup. Opening the top compromises the thermal insulating integrity of the bottle. In addition, especially in the case of large bottles or bottles that are full, tipping the bottle to dispense the right amount of liquid without spillage can be problematic.

Urns and water jugs are known in which a large container has a built-in stopcock at the bottom of the vessel. A beverage is dispensed through the stopcock under force of gravity. Such vessels are not very portable and may not have good insulating qualities. In addition, because the stopcock must be at the very bottom of the vessel to permit the entire contents of the vessel to be dispensed, the vessel must be placed on an elevated platform with the spout hanging over the edge of the platform to allow a cup to be placed beneath the stopcock.

Beer kegs are known in which a large metal container includes a bicycle-type pump attached to the outside top of the keg. Actuating the pump pressurizes the contents of the keg, thereby permitting beer to be dispensed through a hose without opening or tipping the keg. The pump is a manually operated, direct action pump with a reciprocating piston and is coupled to the upper end of the keg. Such a pump adds bulk to the upper end of the keg.

Stainless steel growlers are known that include a bottle with a lid clamped to its upper end. A port for a CO₂ cartridge is sometimes provided on the lid and is in communication with the interior of the bottle. The user can couple a CO₂ cartridge to the cartridge port and inject food-grade CO₂ into the bottle to pressurize the interior of the bottle. A tube in fluid communication with the interior of the bottle has a tap on its end by which the user can dispense a beverage under pressure. A disadvantage of these designs is that operation is completely dependent upon a charged CO₂ cartridge, which must be purchased at extra cost. If no charged CO₂ cartridge is available, there is no way to pressurize the bottle.

Containers of a type often used as garden sprayers are known that include an integral pump. A hose is mounted to the container in fluid communication with the interior of the container and has a nozzle at its free end. A fluid such as a pesticide or weed treatment is placed within the container, and the user operates the pump to increase pressure inside the container. The pump is a manually operated, direct action pump with a piston that reciprocates within a cylinder. The user operates the nozzle at the end of the hose to dispense fluid from the container under pressure. A disadvantage of this design is that the cylinder extends downward, well into the container, and occupies space within the container that would otherwise be available to hold fluid. In addition, the travel of the piston is lengthy, making the pump inconvenient to operate.

### BRIEF SUMMARY OF THE INVENTION

The present invention relates to a beverage bottle having a lid at its upper end. The beverage bottle may be of the type known as a “growler,” which is a bottle having a capacity greater than a typical water bottle. A pressurization system and a dispensing system are operatively associated with the lid. With a beverage in the bottle, a user can utilize the pressurization system to increase the pressure in the space within the bottle not occupied by the beverage to a pressure above that of the ambient. When the user activates the dispensing system, the pressure within the bottle attempts to equalize with the ambient pressure. This pressure differential forces the beverage through the dispensing system and out of the bottle. Thus the beverage can be dispensed without the user having to tilt or manipulate the bottle.

In a disclosed embodiment the pressurization system includes a piston reciprocally mounted within a cylinder in the lid. The piston is spring biased to a raised position. The user presses down on the piston to pump air into the bottle, increasing the pressure within the bottle. When the user releases downward pressure on the piston, the spring returns the piston to its raised position, ready to be pressed again.

In one embodiment the dispensing system includes a flexible hose having one end connected to the lid in fluid communication with the interior of the bottle. A stopcock is mounted on the free end of the hose. With the contents of the bottle under pressure, opening the stopcock at the end of the hose dispenses a quantity of the beverage through the hose without the user having to contact the bottle.

### BRIEF DESCRIPTION OF THE SEVERAL VIEWS OF THE DRAWINGS

FIG. 1 is a side view of a first embodiment of a vessel with integral pressurization and dispensing systems.

FIG. 2 is a side view of the vessel of FIG. 1 partially cut away to reveal interior detail.

FIG. 3 is an exploded side view of the vessel of FIG. 1, showing a lid assembly and a bottle.

FIG. 4 is a side view of the lid of the vessel of FIG. 1.

FIG. 5 is a side cutaway view of the lid assembly of FIG. 4.

FIG. 6 is a side view of a piston of the bottle of FIG. 1.

FIG. 7 is an isometric view of the piston of FIG. 6.

FIG. 8 is a vertical cross section of the piston of FIG. 6.

FIG. 9 is an exploded side view of components of the lid assembly of the pressurizable vessel of FIG. 1, showing the lid of FIG. 4, the piston of FIG. 6, and a compression spring.

FIG. 10 is an assembled side cutaway view of the components of FIG. 9, with the piston in a raised position.

FIG. 11 is an assembled side view of the components of FIG. 9, illustrating the piston in a depressed position.

FIGS. 12 and 13 are side cutaway views of the pressurizable bottle of FIG. 1, showing actuation of the piston to pressurize the bottle.

FIG. 14 is a side cutaway view of the pressurizable bottle of FIGS. 12 and 13, showing liquid being dispensed from the bottle through a hose under pressure.

FIG. 15 is a side cutaway view of the pressurizable bottle of FIG. 14, showing the hose removed and replaced by a beverage adapter with a stopcock to dispense liquid under pressure directly from the upper end of the bottle.

FIGS. 16 and 17 are side cutaway views of an alternate arrangement for coupling a dispensing hose to the lid.

FIG. 18 is a side view of another embodiment of a pressurizable bottle wherein the bottle employs an offset pump button.

FIGS. 19 and 20 are partially cutaway schematic views of the lid assembly of the pressurizable vessel of FIG. 18, showing depressing and releasing the offset button to move the piston within its bore.

FIG. 21 is a side view of a further embodiment of a vessel with pressurizable dispensing system.

FIG. 22 is a top view of the lid of the vessel of FIG. 21.

FIG. 23 is an exploded view of a clamp assembly of the vessel of FIG. 21 for clamping a lid to the upper end of the vessel.

FIG. 24 is an assembled view of the clamp assembly of FIG. 22.

FIGS. 25-27 are schematic side views of a portion of the clamp and lid of the vessel of FIG. 21, wherein FIG. 25 shows the clamp in a disengaged position, FIG. 26 shows the clamp engaging the lid but unlocked, and FIG. 27 shows the clamp in a locked position.

FIG. 28 is an isometric view of a further embodiment of a lid for a pressurizable beverage system with a schematic representation of a valve for coupling a CO₂ cartridge to the lid.

FIG. 29 is a side view of still another embodiment of a lid for a pressurizable beverage system with a schematic representation of a valve for coupling a CO₂ cartridge to the cap of a pouring spout on the lid.

### DETAILED DESCRIPTION OF THE INVENTION

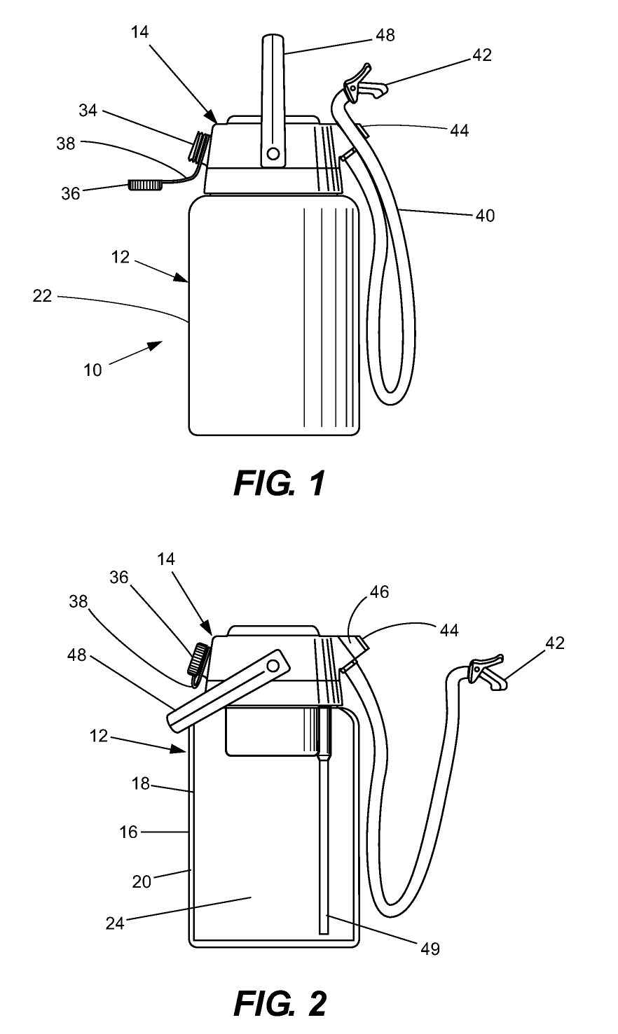

Referring now to the drawings, in which like numerals indicate like elements throughout the several views, FIGS. 1-3 show a beverage container 10 with integral pressurization and dispensing systems. The beverage container 10 comprises a bottle 12 and a lid 14. The bottle 12 is of stainless steel construction. As seen in FIG. 2, the bottle 12 has outer and inner walls 16, 18 in spaced apart relation. The space 20 between the outer and inner walls 16, 18 is partially evacuated of air to create a vacuum that enhances the thermal insulating qualities of the bottle 12.

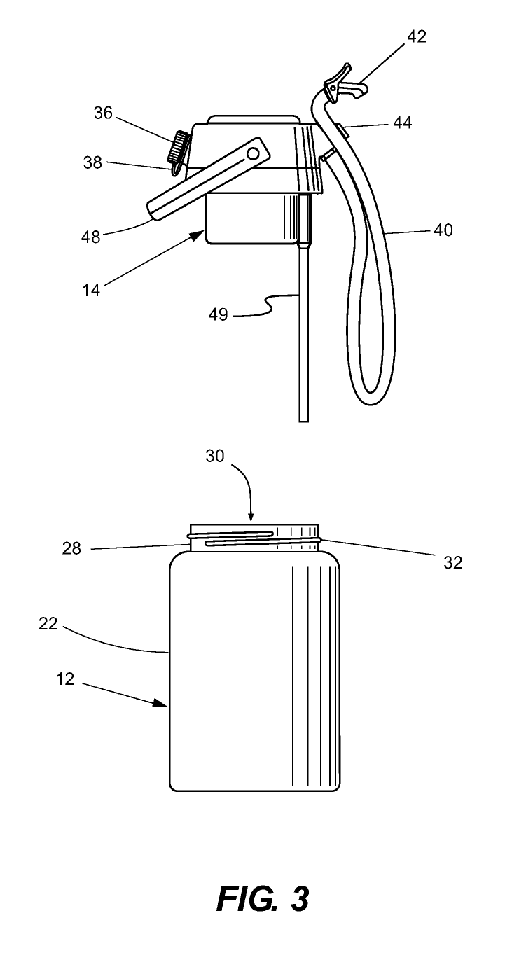

As seen in FIGS. 2 and 3, the bottle 12 has a hollow cylindrical main body portion 22 defining a chamber 24. A cylindrical neck 28 extends upward from the upper end of the bottle 12. The neck 28 defines a hollow bore 30 in fluid communication with the chamber 24 of the bottle 12. Threads 32 are formed on the exterior surface of the neck 28.

The lid 14 includes a pouring spout 34 having a removable cap 36 that snaps or screws onto the end of the spout. The cap 36 is attached to the pouring spout 34 by a tether 38.

A flexible hose 40 has a first end attached to the lid 14. A stopcock 42 is attached to the opposite end of the hose 40. A hose retaining bracket 44 is attached to the lid 14 and includes a circular opening 46 into which an upper portion of the hose 40 can be received to hold the hose by an interference fit until needed.

A generally U-shaped handle 48 is pivotably mounted to the lid 14 and is movable between an upwardly extending position, as shown in FIG. 1, and a lowered, stowed position, as shown in FIG. 2.

An elongated tube 49 extends downward from the lid 14. The tube is of a length such that, when the lid 14 is screwed onto the bottle 12, the lower end of the tube 49 terminates at a point spaced only slightly above the base of the chamber 24 of the bottle.

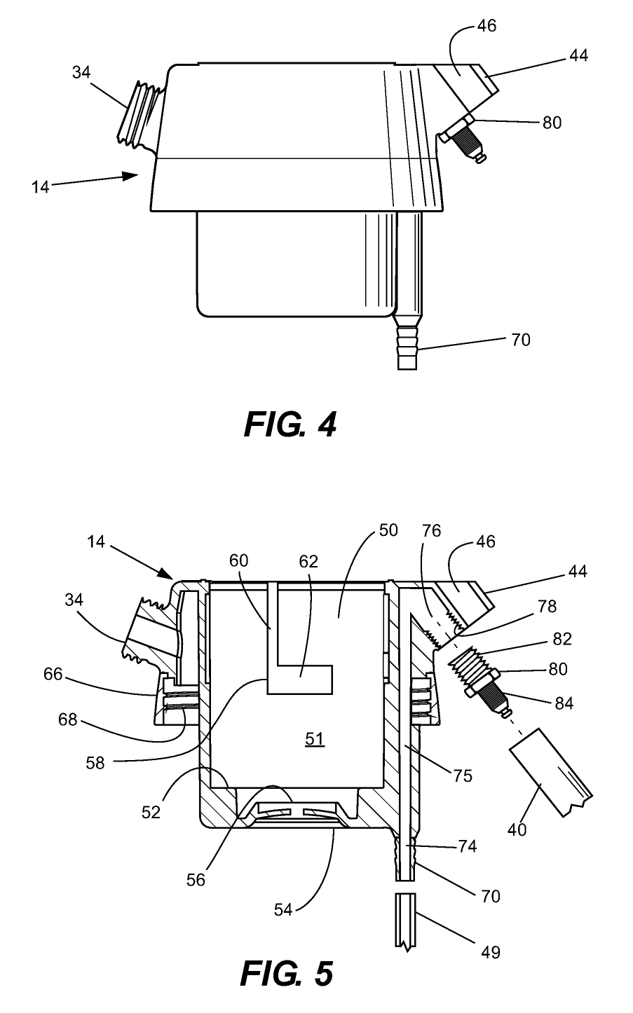

Referring to FIGS. 4 and 5, the lid 14 defines a vertical bore 50 therewithin. The bore 50 has a bore wall 51. An annular ledge 52 is formed in a lower portion of the bore 50. A wall 54 beneath the annular ledge 52 defines the lower end of the bore 50. A check valve 56 is located in the wall 54 and allows air to pass from the bore 50 into the chamber 24 of the bottle 12 but not to allow air to pass back into the bore.

FIG. 5 shows one of two opposed L-shaped channels 58 formed in the wall 51 of the bore 50. The channel 58 has a vertical portion 60 and a horizontal portion 62.

Referring further to FIG. 5, an annular skirt 66 surrounds the main portion of the lid 14. Threads 68 on the inner surface of the skirt 66 are configured to engage the threads 32 on the exterior surface of the neck 28 of the bottle 12.

At the lower end of the lid 14 near its periphery is a barb-type tube connector 70 for coupling the tube 49 to the lid 14. A passage 74 is axially formed through the tube connector 70 and has a vertical portion 75 extending upward through the lid 14 toward the upper end of the lid. Just short of the upper end of the lid 14, the passage 74 extends outward and downward to form a port 76. Threads 78 are formed on the cylindrical wall defining the port 76.

A hose fitting 80 has a threaded end 82 and a barb end 84. The male threaded end 82 of the hose fitting 80 screws into the threads 78 in the port 76. One end of the hose 40 fits onto the barb end 84 of the fitting 80.

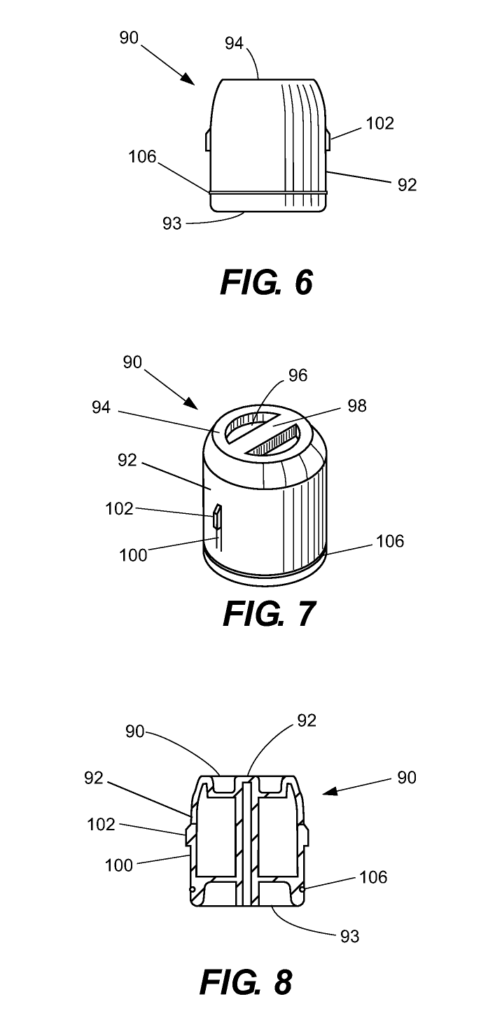

Referring now to FIGS. 6-8, a piston 90 includes a generally cylindrical piston body 92. As seen in FIG. 8, the piston 90 of the disclosed embodiment is hollow to conserve material and to minimize weight. The piston has a lower end 93 and defines a button 94 at its upper end. The button 94 has a central recess 96 and includes a diametric finger grip 98 that a user can grasp to aid in rotating the piston 90.

On each side of the piston 90 the piston body 92 is vertically slotted in the shape of an inverted “U” to form a pair of vertically elongated arms 100 joined to the rest of the piston body 92 at their lower ends to form live springs. A tab 102 is formed at the upper end of each spring arm 100. Each tab 102 has a downwardly sloped upper surface and vertical side walls.

A piston ring 106 is mounted within a corresponding race on the lower outside wall of the piston body 92.

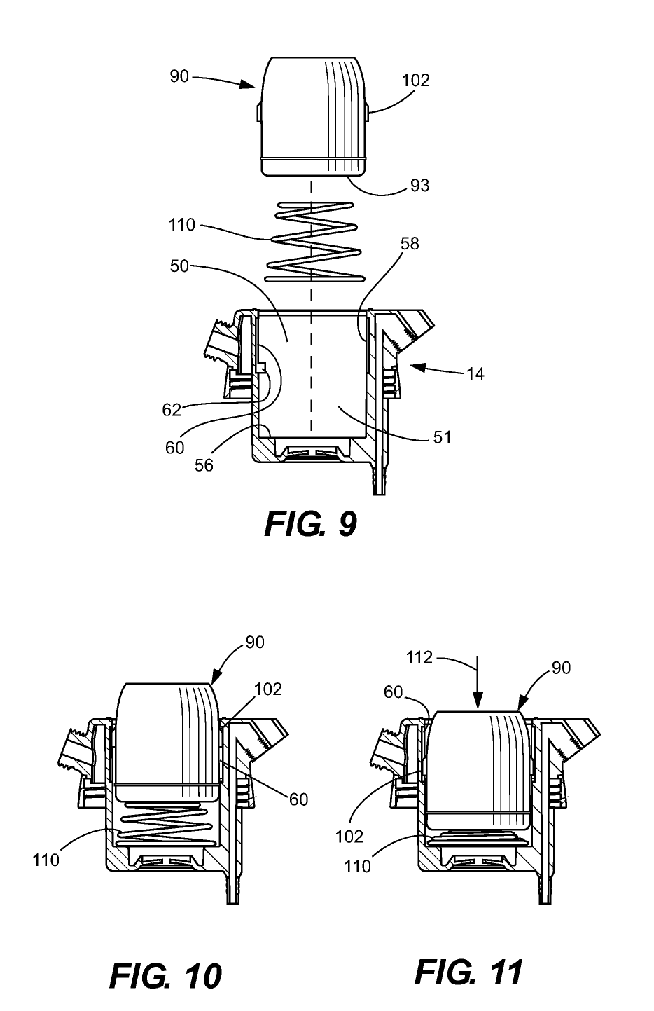

Referring now to FIGS. 9-11, a coil spring 110 is positioned within the base of the bore 50 of the lid 14. The lower end of the coil spring 110 rests on the annular ledge 56 at the base of the bore 50. Advantageously the coil spring 110 can be configured such that each coil is smaller than the coil below it. Thus, as the spring 110 is compressed, the coils nest within one another, rather than stacking on top of one another, to occupy minimal vertical space within the bore 50.

The piston 90 is reciprocally mounted within the bore 50 for vertical movement. The lower end 93 of the piston 90 rests atop the coil spring 110. The coil spring 110 normally biases the piston 90 upward to a raised position, as shown in FIG. 10. The piston 90 can be forced downward to a depressed position, as shown by the arrow 112 in FIG. 11, compressing the coil spring 110. When the force is removed, the spring 110 returns the piston 90 to its uppermost position shown in FIG. 10.

The tabs 102 of the piston 90 ride within the vertical channels 60 in the wall 51 of the bore 50. The piston 90 can be stowed in its depressed position by displacing the piston downward until the tabs 102 reach the bottom of the vertical channels 60. The user then rotates the piston 90 clockwise, as seen from above, causing the tabs 102 of the piston to move within the horizontal channels 62. The tabs 102 are thus out of alignment with the vertical channels 60 in the bore wall, preventing the piston 90 from moving upward. To return the piston 90 to its freely vertical moving state, the user rotates the piston counterclockwise until the tabs 102 are realigned with the vertical channels 60 in the wall of the bore 50. The piston 90 is thus once again freed for vertical reciprocal movement within the bore.

When the piston 90 is locked in its lowermost position, as shown in FIG. 11, the button 92 and upper end of the piston are nearly flush with the upper surface of the lid 14. When the piston 90 is unlocked and biased by the coil spring to its uppermost position shown in FIG. 10, the button 92 extends above the upper surface of the lid 14.

Operation of the apparatus 10 to dispense a beverage will now be explained. The user removes the lid 14 and pours a cold or hot beverage of choice—for example, water, soft drink, beer, or hot coffee—into the bottle 12. The lid 14 is then replaced. The double-walled, thermally insulated, stainless steel bottle 12 keeps the beverage at or near the desired temperature for an extended period of time.

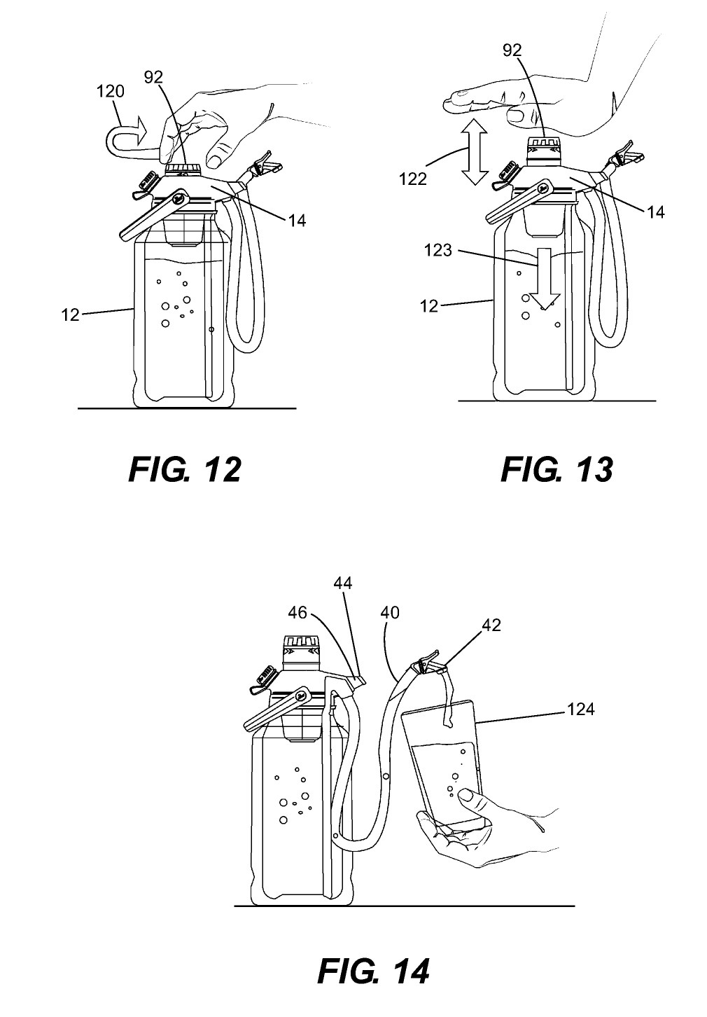

As shown in FIG. 12, the user rotates the button 92 on the top of the piston 90 in a counterclockwise position, as shown by the arrow 120. This rotation brings the tabs 102 on the sides of the piston 90 into alignment with the vertical channel 60 formed in the wall 51 of the bore 50, as previously explained with regard to FIGS. 9-11, freeing the piston for vertical reciprocal movement.

The user then presses downward repeatedly on the button 92 and then releases it, as shown by the arrow 122 in FIG. 13. The downward movement of the piston 90 forces air into the bottle 12, as shown by the arrow 123. The check valve 56 in the base of the bore 50 (see FIG. 5) allows air to pass into the bottle 12 but not to flow back out of the bottle. Thus each successive depression of the piston 90 increases the pressure in the portion of the bottle 12 not occupied by the beverage. At the end of each downward movement, the user releases pressure on the button 92, and the coil spring 110 automatically returns the piston to its uppermost position, ready for the next downward pressure.

This press-downward-and-release action is repeated until the user feels resistance to further pumping, which indicates that the bottle 12 is pressurized. The user then stows the button 92 by pressing the button all the way down and rotating the button clockwise.

Pressurizing the bottle 12 forces fluid into the lower end of the tube 49, up through the tube to the passage 74 formed within the lid 14, into the discharge port 76, and thence into the hose 40.

A feature of the piston 90 of the disclosed embodiment 10 is that the diameter of the piston is large in comparison to the piston's vertical travel. The amount of air moved by a single stroke of the piston is equal to the area of the piston multiplied by the length of travel of the piston. Thus increasing the diameter of the piston allows the length of travel of the piston to be minimized while still moving the same amount of air per stroke. And minimizing the vertical travel of the piston permits the vertical profile of the lid to be minimized.

Once the bottle 12 is pressurized, the user can dispense a serving of the beverage as shown in FIG. 14, either immediately or at some later time. The user uncouples the hose 40 from the hose retainer clip 44 and aims the stopcock 42 at the end of the hose into a suitable container 124, such as a drinking glass, cup, or tumbler. Depressing the lever on the stopcock 42 allows the beverage to flow into the container 124 under pressure. When the desired amount of beverage has been dispensed, the user releases the lever, shutting off flow through the hose.

When the dispensing procedure is completed, the hose 40 can be stowed by pressing a section of the hose adjacent the stopcock 42 into the hose clip 44.

If the user simply wishes to pour a single serving of a beverage from the bottle 12 into a drinking cup, the cap 36 can be removed from the pouring spout 34 on the lid 14. The user then tilts the bottle 12 in the conventional fashion to pour the beverage from the spout 34 into the drinking cup under force of gravity. However, in most cases, particularly in the case of a larger capacity bottle 12, for example, 64 or 128 fl. oz., or a bottle that is full, the drink vessel 10 may be too heavy or cumbersome to maneuver to pour a desired volume of drink into a cup without spilling or overflowing. In this instance, the user can take advantage of the pressurizable feature of the drink vessel 10.

If desired, a beverage can be dispensed through the hose 40 without removing the end of the hose from the hose clip 44. The user simply places the container 124 beneath the stopcock 42 and operates the stopcock to dispense the beverage, as shown in FIG. 14.

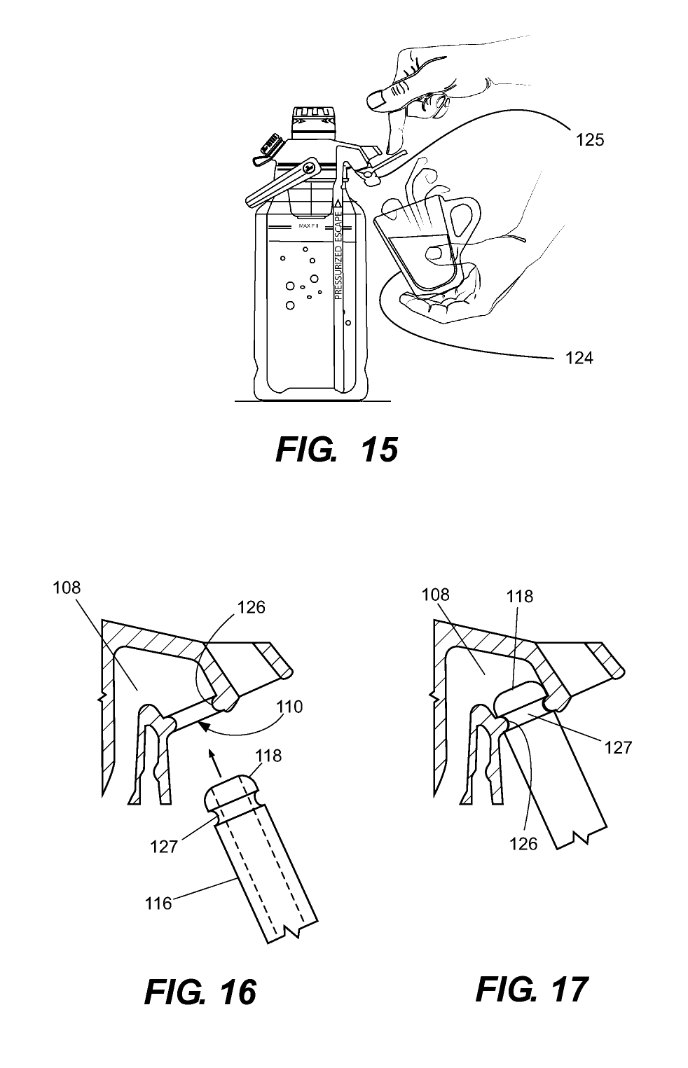

In a variation on the design, shown in FIG. 15, the hose 40 can be disconnected from the outlet port of the lid 14, and a stopcock 125 plugged directly into the outlet port to dispense the beverage under pressure directly from the lid 14.

FIGS. 16 and 17 illustrate an alternate arrangement for coupling the hose 40 to the lid 14, in lieu of the hose fitting shown in FIGS. 4 and 5. An annular flange 126 extends inward around the opening of the outlet port 76. A corresponding annular recess 127 is formed in the hose 40 adjacent its end. Preferably the leading edge 128 of the hose 40 is beveled to facilitate introducing the end of the hose into the outlet port 76. When the end of the hose 40 is inserted into the outlet port 76, the annular flange 126 snaps into the recess 127 in the hose, coupling the hose to the lid 14.

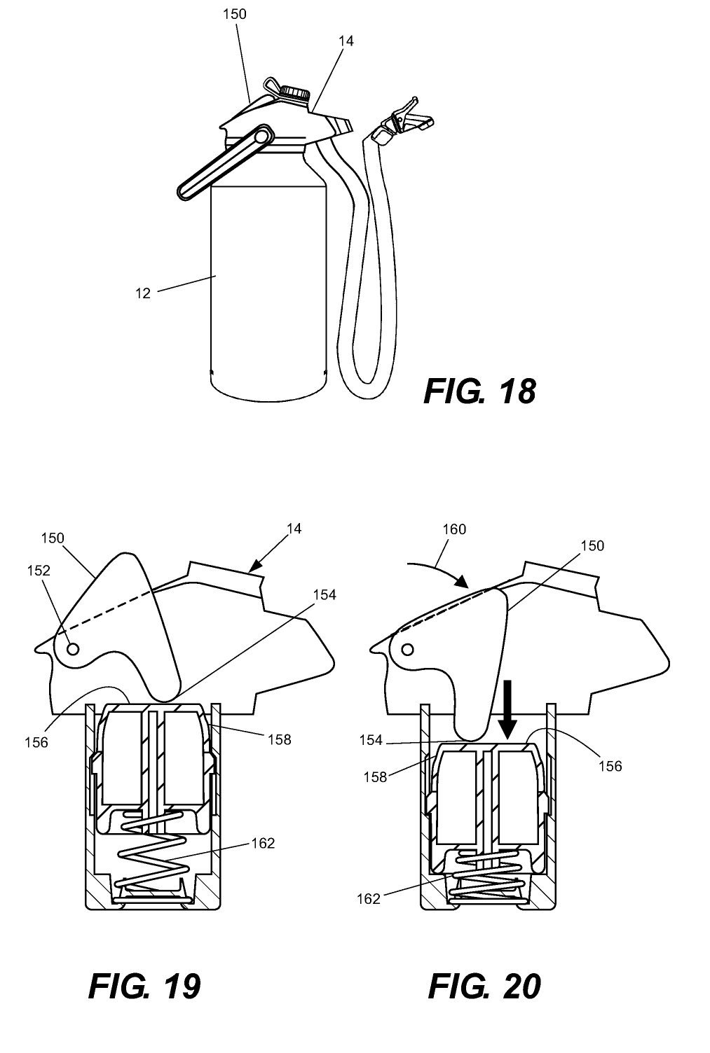

FIGS. 18-20 illustrate a further embodiment of a pressurizable drink vessel. Instead of the user pressing directly on the upper end of the piston, as shown in previous embodiments, a cam-shaped button 150 is mounted to the lid 14. The button 150 pivots about a pin 152 adjacent the outer edge of the lid. A cam lobe 154 rests against the upper end 156 of the piston 158. When the user presses the button 150, the button pivots around the pin 152 in the direction indicated by the arrow 160, and the cam lobe 154 pushes the piston 158 downward. When the user releases pressure on the button 150, a coil spring 162 biases the piston 158 back to its uppermost position, returning the button to its raised position. By repeatedly pressing and releasing the button 150, the user can pressurize the bottle.

Optionally the exposed portion of the button 150 and adjacent portions of the lid 14 can be encapsulated in a flexible material to overlie the space between the button and the slot in the lid to protect the user against possible (but unlikely) pinching as the button is operated.

In lieu of a button 150 having a cam lobe 154, the button can exert a force on the upper end 156 of the piston 158 by way of a separate, intervening mechanical member, such as a push rod.

All of the embodiments disclosed above have an externally threaded bottle neck and a mating internally threaded lid. However, it will be understood that the lid with pressurization system can be used with an internally threaded bottle neck and an externally threaded lid.

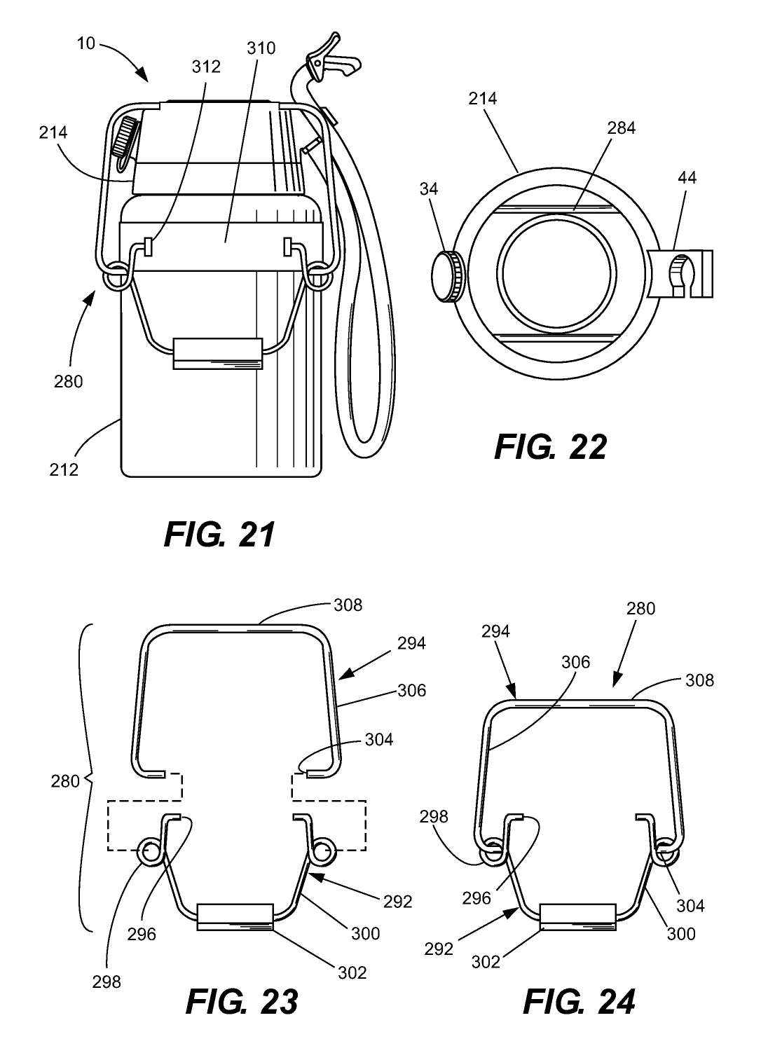

Further, in place of threads on the bottle neck and lid, a clamp assembly operatively associated with the bottle and lid can be employed to clamp the lid securely to the upper end of the bottle. An alternate embodiment 210 of a pressurizable drink vessel is illustrated in FIGS. 21-27. The embodiment 210 uses a clamp assembly 280 at the upper end of the bottle 212 to secure the lid 214 to the upper end of the bottle, in lieu of cooperating threads of other disclosed embodiments. Clamp assemblies and variations thereof for clamping a lid onto a bottle are known in the art, and so the clamp assembly 280 will be described only briefly.

The bottle 212 is similar to the bottle 12 described above, with the exception that neither the neck nor the lid of the bottle is threaded. In addition, the handle is not shown in FIGS. 21-27 for purposes of clarity. As shown in FIG. 22, the lid 214 has a pair of parallel channels 284 formed in or on the lid's upper surface. Otherwise the features of the lid 214 are largely the same as those of the lid 14 previously described.

The channels 284 can be oriented parallel to a diameter extending between the pouring spout 34 and the hose clip 44, as illustrated in FIG. 22, or the channels 284 can be oriented perpendicular or at another suitable angle to the diameter extending between the pouring spout 34 and the hose clip 44.

Referring to FIGS. 23 and 24, the clamp arrangement 280 includes a pair of levers 292 and a pair of links 294 formed from rigid wire or other suitable material. The levers 292 have pivot pins 296 at each end. Adjacent each pivot pin 296, a loop 298 is formed. The free ends of the loops are joined by a connecting member 300. Optionally, a finger-receiving pad 302 is mounted to each connecting member 300.

Each link 294 of the clamp arrangement 280 has coupling pins 304 at each end. Connectors 306 extend upward from each coupling pin 304, and a lid-engaging member 308 joins the upper ends of the connectors.

A circumferential band 310 is mounted to the main body portion 222 of the bottle 212 (FIG. 21). Advantageously, the band 310 fits into a circumferential channel formed in the outer surface of the bottle 212. The levers 292 are pivotably mounted to the bottle 12 by the pivot pins 296 engaging corresponding brackets 312 on the circumferential band 310. In turn, each lever 292 is mounted to a corresponding link 294 by the coupling pins 304 of the links engaging the loops 298 of the levers 292.

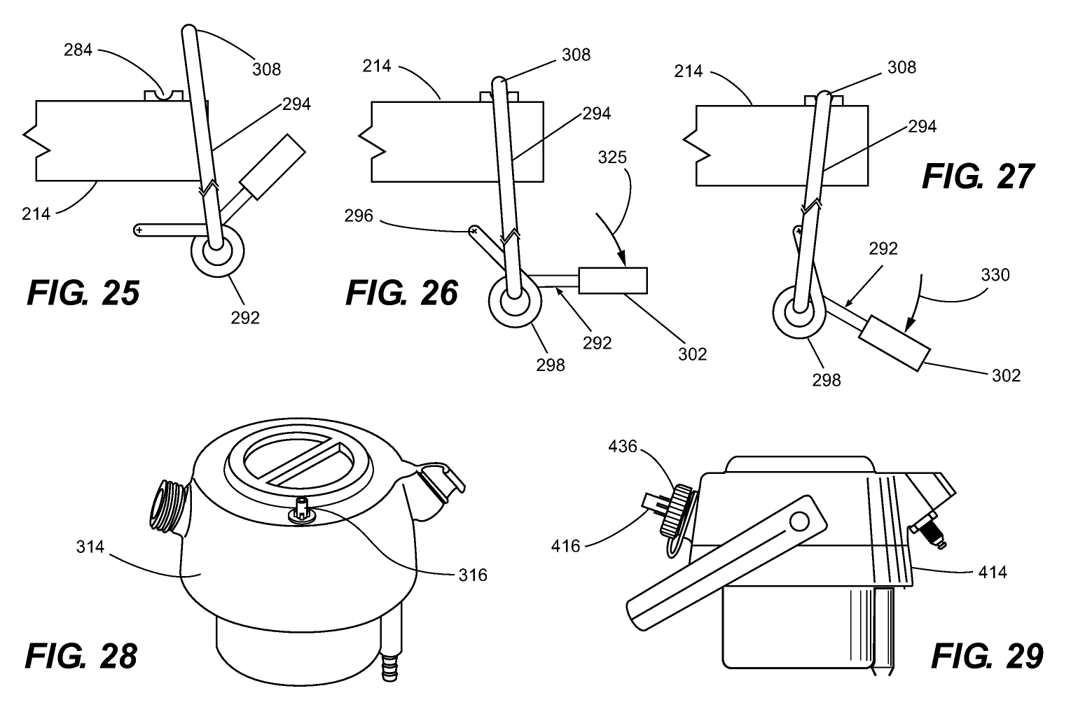

Referring to FIG. 25, the lever 292 is illustrated rotated to an upper position. In this upper position the lower ends of the links 294 are sufficiently raised that the lid-engaging member 308 of each link can swing up and over the lid 214.

In FIG. 26 the user has pivoted the lever 292 downward about its pivot pins 296, such as by pressing the finger-receiving pad 302 on the lever downward, as indicated by the arrow 325. Because the loops 298 of the levers 292 are offset with respect to the pivot pins 296, downward rotation of the levers displaces the loops downward, exerting tension on the links 294. This tension draws the lid-engaging member 308 of each link 294 downward and into the corresponding channel 284 in the upper surface of the lid 214.

Referring now to FIG. 27, additional downward pressure on the pad 302, illustrated by the arrow 330, rotates the link 294 further downward. This additional rotation displaces the loop 298 further downward, exerting additional tension on the links 294 that pulls the lid-engaging member 308 of each link downward. This additional downward tension on the links 294 pulls the lid 214 tightly against the upper end of the bottle, clamping the lid securely in place.

To remove the lid 214 from the bottle, such as to refill the bottle, the reverse sequence is followed. The user lifts the pads 302 of the levers 292, rotating the levers and displacing the loops 298 upward. This upward movement of the loops 298 releases the tension on the links 294 and permits the lid-engaging member 308 of each link to lift out of its associated channel 282 in the upper surface of the lid 214. The links 294 are then pivoted out of the way, as shown in FIG. 25, providing unobstructed access to remove the lid.

The pressurizable drink vessel 210 can have a carrying handle mounted to the lid, as with the pressurizable drink vessel 10, or it can have a carrying handle mounted to the circumferential band 310 affixed to the bottle 214.

FIG. 28 illustrates still another embodiment of a lid for a pressurizable beverage container. A lid 314 is in most respects similar to the lid 14 described previously. In addition to the features of the lid 14, however, the lid 314 includes a port 316 in communication with the chamber 24 of the bottle 12 that will couple to food-grade CO₂ cartridges. The port 316 affords a second way to pressurize the bottle 12. If a CO₂ cartridge is available, the cartridge can be coupled to the port to pressurize the air within the bottle. If a CO₂ cartridge is not available, or the user simply wishes to avoid the expense of a cartridge, the user can pressurize the bottle by pressing the button 92 on top of the piston, in the manner described above.

FIG. 29 illustrates still another embodiment of a lid 414 for a pressurizable beverage container. The lid 414 is in most respects similar to the lid 314 described above. However, instead of the CO₂ port being mounted to the housing of the lid 314, a port 416 for coupling food-grade CO₂ cartridges is mounted to the cap 436 of the pouring spout. Thus a beverage container 10 can be converted to CO₂ capability simply by replacing the original cap 36 with a cap 436 with integral CO₂ port.

Because all of the elements of the pressurization and dispensing systems of the foregoing disclosed embodiments are built into the lid, a conventional growler can be converted to one with a pressurization and dispensing system simply by replacing the lid.

As used herein, words such as top, bottom, left, right, horizontal, vertical, and the like are used with reference to the drawings for convenience of description. Unless stated otherwise, use of such words is not intended to limit the invention to any particular orientation.

Finally, it will be understood that the foregoing embodiments have been disclosed by way of example, and that other modifications may occur to those skilled in the art without departing from the scope and spirit of the appended claims.

1. A pressurizable bottle for containing and dispensing liquid, comprising:
a bottle defining a chamber having a base, said bottle having an upper end;
a lid mounted to said upper end of said bottle, said lid comprising a wall defining a bore therewithin;
a piston mounted within said bore in said lid for reciprocating movement between an upper position and a lower position;
a spring mounted within said bore and operatively associated with said piston such that said spring is normally operative to bias said piston to said upper position;
means accessible from outside said lid by which a user can depress said piston from said upper position to said lower position;
a one way valve in fluid communication with said bore and said chamber of said bottle, said one way valve being operative to allow air to pass from said bore to said chamber but not to allow air to pass from said chamber to said bore;
means defining a fluid flow path from a location adjacent said base of said chamber of said bottle, through said lid, and through a discharge port in said lid opening exterior to said chamber; and
fluid flow control means normally operative to prevent liquid from exiting said discharge port and selectively operable to allow liquid to exit said discharge port;
whereby when said chamber of said bottle contains a liquid, repeated depression of said piston by a user forces air into said chamber, pressurizing the contents of said chamber;
whereby pressurizing the contents of said chamber forces said liquid through said means defining said fluid flow path and to said discharge port;
whereby said fluid flow control means normally prevents said liquid from exiting said discharge port under pressure; and
whereby said fluid flow control means is selectively operative to allow said fluid to exit said discharge port under pressure.

2. The pressurizable bottle of claim 1, wherein said fluid flow control means normally operative to prevent liquid from exiting said discharge port and selectively operable to allow liquid to exit said discharge port comprises:
a flexible hose having first and second ends, said first end of said hose being mounted to said discharge port; and
a discharge valve mounted to said second end of said hose, said discharge valve being normally operative to prevent liquid from exiting said discharge port and selectively operable to allow liquid to exit said discharge port.

3. The pressurizable bottle of claim 2, further comprising a hose fitting having a first end configured to engage said discharge port and a second end configured to engage said flexible hose;
wherein said flexible hose is mounted to said discharge port by said first end of said hose fitting engaging said discharge port and said second end of said hose fitting engaging said flexible hose.

4. The pressurizable bottle of claim 2, further comprising a hose retaining bracket extending from said lid, said hose retaining bracket comprising means for holding a portion of said hose adjacent said second end of said hose.

5. The pressurizable bottle of claim 4, wherein said means for holding a portion of said hose adjacent said second end of said hose comprises an opening formed in said bracket dimensioned to create an interference fit with said portion of said hose adjacent said second end thereof,
whereby when said portion of said hose adjacent said second end thereof is inserted into said opening in said bracket, said hose is coupled to said bracket by said interference fit.

6. The pressurizable bottle of claim 1, wherein said fluid flow control means normally operative to prevent liquid from exiting said discharge port and selectively operable to allow liquid to exit said discharge port comprises a discharge valve mounted to said discharge port, said discharge valve being normally operative to prevent liquid from exiting said discharge port and selectively operable to allow liquid to exit said discharge port.

7. The pressurizable bottle of claim 1, wherein said means accessible from outside said lid by which a user can depress said piston from said upper position to said lower position comprises said upper end of said piston being accessible from outside said lid,
whereby said user can depress said piston by pushing directly on the upper end of said piston.

8. The pressurizable bottle of claim 1, wherein said bottle further comprises an upstanding neck at said upper end of said bottle, said upstanding neck having threads formed on an outward facing surface thereof; and
wherein said lid further comprises an annular wall having threads formed on an inward facing surface thereof;
said threads on said neck of said bottle being configured to engage said threads on said annular wall of said lid;
whereby said lid screws onto said neck of said bottle.

9. The pressurizable bottle of claim 1, wherein said bottle further comprises an upstanding neck at said upper end of said bottle, said upstanding neck having threads formed on an inward facing surface thereof; and
wherein said lid further comprises an annular wall having threads formed on an outward facing surface thereof;
said threads on said neck of said bottle being configured to engage said threads on said annular wall of said lid;
whereby said lid screws onto said neck of said bottle.

10. The pressurizable bottle of claim 1, further comprising clamp means operatively associated with said bottle and said lid for securing said lid to said upper end of said bottle.

11. The pressurizable bottle of claim 1, further comprising a carrying handle mounted to said lid.

12. The pressurizable bottle of claim 1, wherein said bottle further comprises a circumferential band, and wherein said bottle further comprises a carrying handle mounted to said circumferential band.

13. The pressurizable bottle of claim 1, further comprising:
a vertical channel formed in said wall defining said bore in said lid; and
a tab extending outward from said piston and riding in said vertical channel in said lid.

14. The pressurizable bottle of claim 13, further comprising:
a horizontal channel formed in said wall defining said bore in said lid and in communication with said vertical channel;
wherein said piston can be depressed to said lower position and rotated such that said tab rides in said horizontal channel and out of alignment with said vertical channel, thereby retaining said piston in said lower position.

15. The pressurizable bottle of claim 1, wherein said means defining a fluid flow path from a location adjacent said base of said chamber of said bottle, through said lid, and through a discharge port in said lid opening exterior to said chamber comprises:
a passage formed in said lid and extending from a first opening located within said chamber of said bottle to a second opening located exterior to said chamber; and
a tube having a lower end located proximate said base of said chamber of said bottle and an upper end in fluid communication with said first opening of said passage in said lid.

16. The pressurizable bottle of claim 15, further comprising a tube connector formed on said lid and having a lumen in fluid communication with said first opening of said passage in said lid;
whereby said tube is mounted to said tube connector to place said tube in fluid communication with said passage in said lid.

17. The pressurizable bottle of claim 1, wherein said lid further comprises a spout in fluid communication with said chamber of said bottle, whereby fluid can be poured through said spout from said bottle without pressurizing said bottle.

18. The pressurizable bottle of claim 1, further comprising a port located on said lid in fluid commination with said chamber of said bottle, said port comprising means for interfacing with a compressed gas cartridge, whereby said bottle can optionally be pressurized with compressed gas.

19. The pressurizable bottle of claim 17, wherein said spout further comprises a cap for closing said spout when not in use, and wherein said cap comprises a port in fluid commination with said chamber of said bottle, said port comprising means for interfacing with a compressed gas cartridge, whereby said bottle can optionally be pressurized with compressed gas.

20. The pressurizable bottle of claim 1, wherein said bottle comprises an outer wall and an inner wall in spaced apart relation creating a space therebetween, and wherein said space has a partial vacuum formed therein;
whereby said bottle provides increased thermal insulating performance.
